(19) United States
(12) Patent Application Publication
(10) Pub. No.: US 2007/0019135 A1
(43) Pub. Date: Jan. 25, 2007

(54) Color filter substrate, liquid crystal display panel including the same and manufacture method thereof

(75) Inventors: Ji-won Sohn, Seoul (KR); Nak-cho Choi, Seoul (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/451,861

(22) Filed: Jun. 13, 2006

(30) Foreign Application Priority Data
Jul. 22, 2005 (KR) 2005-66913

(51) Int. Cl. G02F 1/1335

(52) U.S. Cl. 349/106

(57) ABSTRACT

A color filter substrate includes an insulating substrate; a color filter layer disposed on the insulating substrate and provided with a first region and a second region higher than the first region; an organic layer mountain structure pattern that is disposed in the first region and formed to protrude upward; and a column spacer that is formed simultaneously with the organic layer mountain structure pattern to be disposed in the second region. The color filter substrate is capable of obtaining an improved shape of the organic layer mountain structure pattern even when both the organic layer mountain structure pattern and the column spacer are formed simultaneously.

### CROSS-REFERENCE TO RELATED APPLICATIONS

This application claims priority from Korean Patent Application No. 2005-0066913, filed on Jul. 22, 2005, in the Korean Intellectual Property Office, the disclosure of which is incorporated herein by reference.

### BACKGROUND OF INVENTION

1. Technical Field

The present disclosure relates to a color filter substrate, a liquid crystal display panel including the same and a manufacturing method therefor, and, more particularly, to a color filter substrate on which both an organic layer mountain structure pattern and a column spacer are formed simultaneously, a liquid crystal display panel including the same and a manufacturing method therefor.

2. Discussion of the Related Art

A liquid crystal display panel includes a liquid crystal panel having a thin film transistor substrate on which a thin film transistor is formed, a color filter substrate on which a color filter layer is formed, and a liquid crystal layer interposed therebetween. Since the liquid crystal display panel is a non-light-emitting device, a backlight unit for irradiating light onto the liquid crystal display panel can be disposed on a rear surface of the thin film transistor substrate. An amount of light that is transmitted through the liquid crystal display panel is varied according to an alignment state of the liquid crystal molecules of the liquid crystal layer.

A PVA mode refers to one of the vertical alignment (VA) modes in which incision patterns are formed in a pixel electrode and a common electrode, respectively. That is, it is a method of widening the viewing angle by controlling the falling direction of the liquid crystal molecules, using fringe fields formed by the incision patterns.

Since, however, the electric fields are strong near the incision patterns, alignment of the molecules near the incision patterns is determined rapidly, while molecules farther away from the incision patterns are rearranged by the alignment of the molecules near the incision patterns. Therefore, there is a drawback that the response speed of the liquid crystal is overly slow.

In order to remove the drawback, there has been proposed a structure in which an organic layer mountain structure pattern is formed on the common electrode, instead of forming the incision patterns in the common electrode. Meanwhile, column spacers are formed on the color filter substrate to maintain a cell gap between the color filter substrate and the thin film transistor substrate. The structure using the organic layer mountain structure pattern, however, has a drawback of low productivity because the organic layer mountain structure pattern and the column spacer are formed separately through different processes.

### SUMMARY OF THE INVENTION

Embodiments of the present invention provide a color filter substrate that is capable of obtaining an improved shape of an organic layer mountain structure pattern even when both an organic layer mountain structure pattern and a column spacer are formed simultaneously, and a liquid crystal display panel including the same.

Embodiments of the present invention provide a method of manufacturing a color filter substrate and a liquid crystal display panel, that is capable of improving the shape of an organic layer mountain structure pattern even when the organic layer mountain structure pattern and the column spacer are formed simultaneously.

The foregoing and/or other embodiments of the present invention can be achieved by providing a color filter substrate, comprising an insulating substrate; a color filter layer disposed on the insulating substrate and provided with a first region and a second region higher than the first region; an organic layer mountain structure pattern that is disposed in the first region and formed to protrude upward; and a column spacer that is formed simultaneously with the organic layer mountain structure pattern to be disposed in the second region.

According to an embodiment of the present invention, the color filter layer is provided with a plurality of sublayers of different colors, and at least two sublayers overlap each other in the second region.

According to an embodiment of the present invention, the color filter substrate further comprises a black matrix interposed between the insulating substrate and the color filter layer in the second region.

According to an embodiment of the present invention, the color filter substrate further comprises a common electrode disposed between the organic layer mountain structure pattern and the color filter layer, and between the column spacer and the color filter layer.

Embodiments of the present invention provide a liquid crystal display panel, comprising a thin film transistor substrate on which a thin film transistor is formed; a color filter substrate disposed opposite to the thin film transistor substrate and including an insulating substrate, a color filter layer disposed on the insulating substrate and provided with a first region and a second region higher than the first region, an organic layer mountain structure pattern that is disposed in the first region and formed to protrude toward the thin film transistor substrate, and a column spacer that is disposed in the second region and that is formed from a layer used for forming the organic layer mountain structure pattern; and a liquid crystal layer disposed between the thin film transistor substrate and the color filter substrate.

According to an embodiment of the present invention, the column spacer is disposed on the thin film transistor.

According to an embodiment of the present invention, the thin film transistor substrate is further provided with signal lines insulatedly intersecting each other, and the column spacer is disposed on the signal lines.

According to an embodiment of the present invention, the color filter layer is provided with a plurality of sublayers of different colors, and at least two sublayers overlap each other in the second region.

According to an embodiment of the present invention, the panel further comprises a black matrix interposed between the insulating substrate and the color filter layer in the second region.

According to an embodiment of the present invention, the color filter substrate further comprises a common electrode disposed between the organic layer mountain structure pattern and the color filter layer, and between the column spacer and the color filter layer.

According to an embodiment of the present invention, the liquid crystal layer is a vertical alignment mode.

According to an embodiment of the present invention, the thin film transistor substrate includes a pixel electrode with a pixel electrode incision pattern formed therein.

According to an embodiment of the present invention, a valley portion of the organic layer mountain structure pattern corresponds to the pixel electrode incision pattern.

The foregoing and/or other embodiments of the present invention provide a method for manufacturing a liquid crystal display panel, comprising forming a color filter layer with a first region and a second region higher than the first region on an insulating substrate; forming a common electrode on the color filter layer; forming an organic material layer on the common electrode layer; patterning the organic material layer to form an organic layer mountain structure pattern protruding upward in the first region, and to form a column spacer in the second region, whereby a color filter substrate is prepared; preparing a thin film transistor substrate having a thin film transistor; and combining the color filter substrate and the thin film transistor substrate.

According to an embodiment of the present invention, the color filter layer is provided with a plurality of sublayers of different colors, and at least two sublayers overlap each other in the second region.

According to an embodiment of the present invention, the color filter substrate and the thin film transistor substrate are combined with each other so that the column spacer corresponds to the thin film transistor.

According to an embodiment of the present invention, a thickness of the color filter layer at a first region in which the organic layer mountain structure pattern is disposed is less than that of the color filter layer of the second region in which the column spacer is disposed.

### BRIEF DESCRIPTION OF THE DRAWINGS

Exemplary embodiments of the prevent invention can be understood in more detail from the following descriptions taken in conjunction with the accompany drawings, in which:

FIG. 1 shows a layout view of a thin film transistor substrate of a liquid crystal display panel in accordance with an embodiment of the present invention;

FIG. 2 illustrates a cross-sectional view of the liquid crystal display panel taken along line II-II of FIG. 1;

FIGS. 3A to 3G present cross-sectional views for illustrating a method of manufacturing a color filter substrate in accordance with an embodiment of the present invention; and

FIGS. 4 to 7 set forth cross-sectional views of the liquid crystal display panel in accordance with respective embodiments of the present invention.

### DESCRIPTION OF EXEMPLARY EMBODIMENTS

Reference will now be made in detail to the embodiments of the present invention, examples of which are illustrated in the accompanying drawings, wherein like reference numerals refer to like elements throughout.

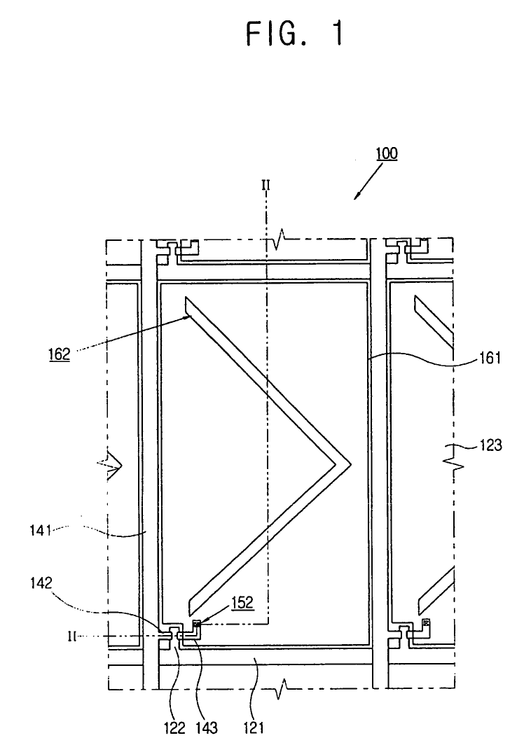

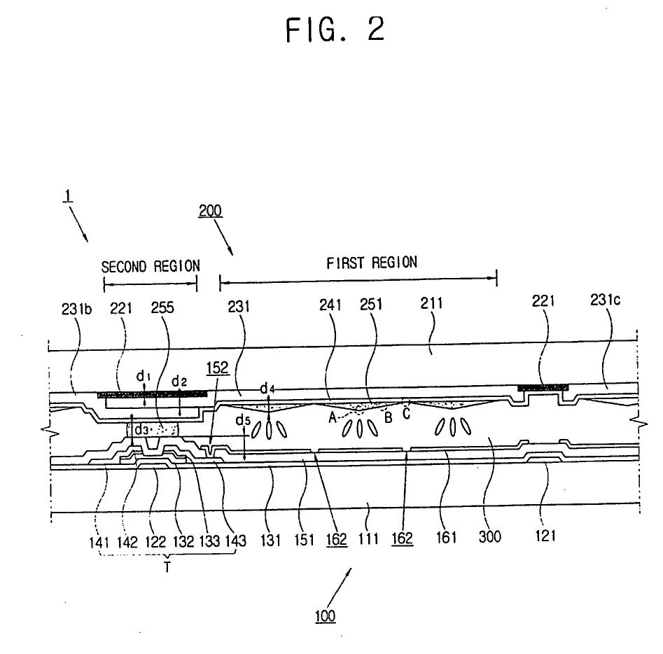

First, a liquid crystal display panel in accordance with an embodiment of the present invention is described with reference to FIGS. 1 and 2. FIG. 1 is a layout view of a thin film transistor substrate in accordance with an embodiment of the present invention, and FIG. 2 is a cross-sectional view of the liquid crystal display panel taken along line II-II of Fig. 1.

A liquid crystal display panel 1 includes a thin film transistor substrate 100, a color filter substrate 200, which are disposed so as to face each other, and a liquid crystal layer 300 interposed between the substrates 100 and 200.

The thin film transistor substrate 100 has a gate wire 121, 122 formed on a first insulating substrate 111. The gate wire 121, 122 may be formed of a single metal layer or multi metal layers. The gate wire 121, 122 is provided with a horizontally extending gate line 121 and a gate electrode 122 of a thin film transistor T connected to the gate line 121. Although not shown in the drawings, the gate wire 121, 122 may be further provided with a common electrode line that overlaps a pixel electrode 161 to form a storage capacitor therebetween.

On the first insulating substrate 111, a gate insulating layer 131 made of SiNx or the like is formed to cover the gate wire 121, 122.

On an upper surface of a portion of the gate insulating layer 131 covering the gate electrode 122, a semiconductor layer 132 made of amorphous silicon or the like is formed. On an upper surface of the semiconductor layer 132, an ohmic contact layer 133 made of silicide or n+ hydrogenated amorphous silicon highly doped with n type impurities is formed. The ohmic contact layer 133 is divided into two portions with respect to the gate electrode 122.

On the ohmic contact layer 133 and the gate insulating layer 131, a data wire 141, 142, 143 is formed. The data wire 141, 142, 143 may also be formed of a single metal layer or multiple metal layers. The data wire 141, 142, 143 is provided with a data line 141 that is formed in a vertical direction to intersect the gate line 121, thereby forming a pixel, a source electrode 142, that is, a branch of the data line 141, extending onto an upper portion of the ohmic contact layer 133, and a drain electrode 143 formed on an upper portion of the ohmic contact layer 133 opposite the source electrode 142 with respect to the gate electrode 122 and separated from the source electrode 142.

On an upper surface of the data wire 141, 142, 143 and portions of the semiconductor layer 132 that are not covered with the data wire 141, 142, 143, a protective layer 151 is formed that is made of silicon nitride, an acryl-based organic insulating layer and an a-Si:C:O layer or an a-Si:O:F layer deposited by a plasma enhanced chemical vapor deposition (PECVD) method. The protective layer 151 is provided with contact holes 152 exposing the drain electrode 143.

The pixel electrode 161 is formed on the upper surface of the protective layer 151. The pixel electrode 161 is usually made of a transparent conductive material such as indium tin oxide (ITO) or indium zinc oxide (IZO).

The pixel electrode 161 is provided with a substantially V-shaped pixel electrode incision pattern 162 formed therein. The pixel electrode incision pattern 162 is formed in order to divide an organic layer mountain structure pattern 251 later described and the liquid crystal layer 300 into multiple domains.

The color filter substrate 200 has black matrix 221 formed on a second insulating substrate 211. The black matrix 221 usually defines color filters of red, green and blue colors, and serves to prevent a direct light irradiation to the thin film transistor T disposed on the thin film transistor substrate 100. The black matrix 221 is made of a photosensitive organic material having a black pigment added thereto. As the black pigment, carbon black or titanium oxide can be used.

A color filter layer 231 is provided with three sublayers 231a, 231b, 231cthat are formed alternatingly between the black matrices 221. The three sublayers 231a, 231b, 231c are formed of red, green and blue filters, respectively. The color filter layer 231 serves to impart color to a light irradiated from a backlight unit (not shown) and then transmitted through the liquid crystal layer 300. The color filter layer 231 is usually made of a photosensitive organic material.

The color filter layer 231 is provided with a first region and a second region higher than the first region. Any one of the three sublayers 231a, 231b, 231c can be located in the first region, and any two of the three sublayers 231a, 231b, 231c overlap each other in the second region. Further, the black matrix 221 is also located in the second region, so that a height difference between the first and the second regions become greater.

On an upper surface of the color filter layer 231, a common electrode 241 is formed that is made of a transparent conductive material such as indium tin oxide (ITO) or indium zinc oxide (IZO). The common electrode 241 and the pixel electrode 161 apply voltage to the liquid crystal layer 300. The common electrode 241 does not have any incision pattern and covers the entire color filter layer 231.

On an upper surface of the common electrode 241, both an organic layer mountain structure pattern 251 and a column spacer 255 are provided and that are formed simultaneously.

The organic layer mountain structure pattern 251 is located in the first region of the color filter layer 231. A cross section of the organic layer mountain structure pattern 251 substantially has a shape of a triangle and is provided with a valley portion A and an inclined or slope portion B. The valleys of the organic layer mountain structure pattern 251 are separated from each other by blank space portions C. The valley portion A of the organic layer mountain structure pattern 251 is provided so as to correspond or be directed to the pixel electrode incision pattern 162.

The organic layer mountain structure pattern 251 makes liquid crystal molecules of the liquid crystal layer 300 have predetermined pretilt angles, and the liquid crystal molecules are rapidly rearranged in directions determined by the pretilt angles when the voltage is applied to the pixel electrode 161.

The column spacer 255 is formed simultaneously together with the organic layer mountain structure pattern 251 and is located in the second region of the color filter layer 231. The column spacer 255 serves to maintain a cell gap between both the substrates 100, 200, and is located corresponding to the thin film transistor T.

As the column spacer 255 is formed on the color filter layer 231, the bottom of the column spacer 255 is higher than the bottom of the organic layer mountain structure pattern 251.

Interposed between the thin film transistor substrate 100 and the color filter substrate 200, the liquid crystal layer 300 is a vertical alignment (VA) mode, in which long axis of liquid crystal molecules therein are at right angles unless a voltage is applied across the liquid crystal layer 300. When the voltage is applied, the liquid crystal molecules fall such that their long axis now lies orthogonal to the applied electric field as their dielectric anisotropy is negative. However, if the pixel electrode incision pattern 162 and the organic layer mountain structure pattern 251 are not formed, falling direction of the liquid crystal molecules is not determined, which results in disorder of their alignment while disclination lines appear at interfaces between different alignments. When the voltage is applied to the liquid crystal layer 300, the pixel electrode incision pattern 162 and organic layer mountain structure pattern 251 generate a fringe field to determine an alignment orientation or alignment direction, of the liquid crystal molecules. Further, the liquid crystal layer 300 is divided into multiple domains by the pixel electrode incision pattern 162 and the organic layer mountain structure pattern 251.

The reason why the column spacer 255 is formed within the second region higher than the first region after the organic layer mountain structure pattern 251 is formed within the first region is illustrated below.

First, problems caused when the organic layer mountain structure pattern 251 and the column spacer 255 are formed simultaneously will be explained.

The height of the valley portion A of the organic layer mountain structure pattern 251 is usually about 1.2 μm, while the height of the column spacer 255 is usually about 4 μm, although it varies according to a desired cell gap value. Therefore, when the organic layer mountain structure pattern 251 and the column spacer 255 are formed simultaneously, an organic material layer of or above 4 μm is required. During the exposure, a mask with slit patterns is used for forming the organic layer mountain structure pattern 251. Because, however, exposure should be increased to form the organic layer mountain structure pattern 251 with a height of about 1.2 μm from the organic material layer of or above 4 μm, gaps between the slits are increased, which leads to a problem that an uneven surface is formed on the organic layer mountain structure pattern 251.

If the organic layer mountain structure pattern 251 with a greater height is formed, the height difference between the organic layer mountain structure pattern 251 and the column spacer 255 will be decreased, so that less exposure is required. Therefore, the gaps between the slits can be decreased, thereby lessening the formation of the uneven surface. However, there is a problem that light efficiency is degraded because of the increased thickness of the organic layer mountain structure pattern 251.

In an embodiment of the present inention, such problems are resolved by forming the column spacer 255 within the second region higher than the first region after forming the organic layer mountain structure pattern 251 within the first region.

Any one of the three sublayers 231a, 231b, 231c can be located in the first region, while two of the three sublayers 231a, 231b, 231c overlap each other in the second region. Further, the black matrix 221 is also located at the second region.

A thickness d1 of the black matrix 221 is usually about 1.5 μm, and a thickness d2 of the sublayers 231a, 231b, 231c is usually about 1.8 μm. Therefore, the second region protrudes over the first region toward the thin film transistor substrate 100 by about 3.3 μm. In the first embodiment, the thickness d3 of the column spacer 255 for maintaining the required cell gap is reduced by forming the column spacer 255 in the protruding second region. Accordingly, the difference between the thickness d4 of the organic layer mountain structure pattern 251 and the thickness d3 of the column spacer 255 is reduced.

As the thickness d3 of the column spacer 255 is reduced, the organic material layer used for forming the organic layer mountain structure pattern 251 and the column spacer 255 during a manufacture process of the color filter substrate 200 described later can also be reduced. If the thickness of the organic material layer is reduced, the exposure time used for forming the organic layer mountain structure pattern 251 can be reduced. Therefore, the gap between the slits can be reduced, so that the formation of the uneven surface on the organic layer mountain structure pattern 251 can be reduced.

Further, the column spacer 255 is in contact with the thin film transistor T of the thin film transistor substrate 100. Unlike a pixel area corresponding to the first region, the thin film transistor T is provided with the gate electrode 122, the semiconductor layer 132, the ohmic contact layer 133, the source electrode 142, and the drain electrode 143, so that it protrudes toward the color filter substrate 200. A thickness difference d5 between a portion where the thin film transistor is formed and the pixel area is about 0.5 μm. Therefore, the required thickness d3 of the column spacer 255 is further reduced.

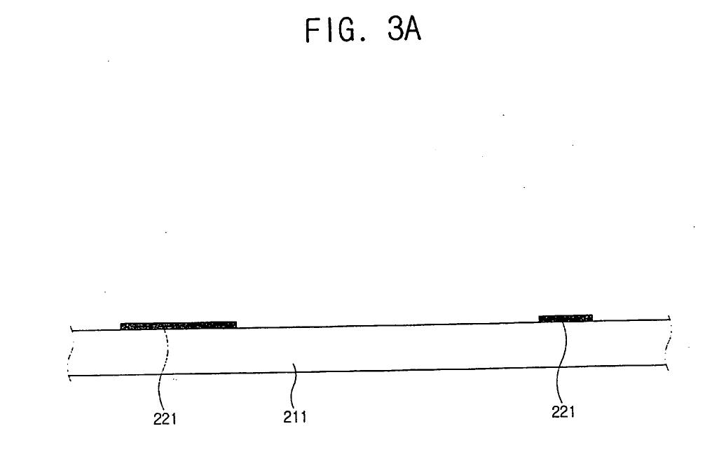

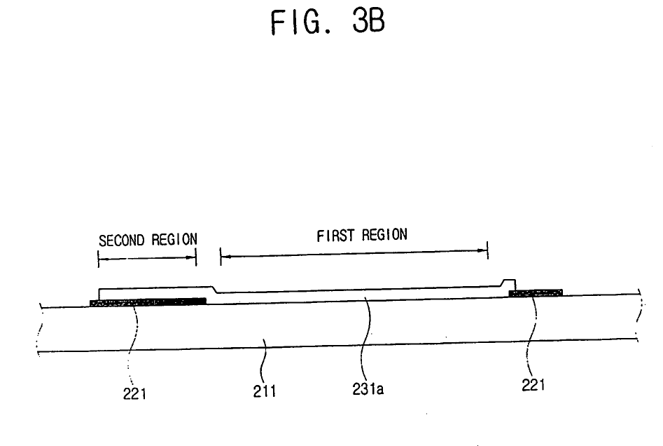

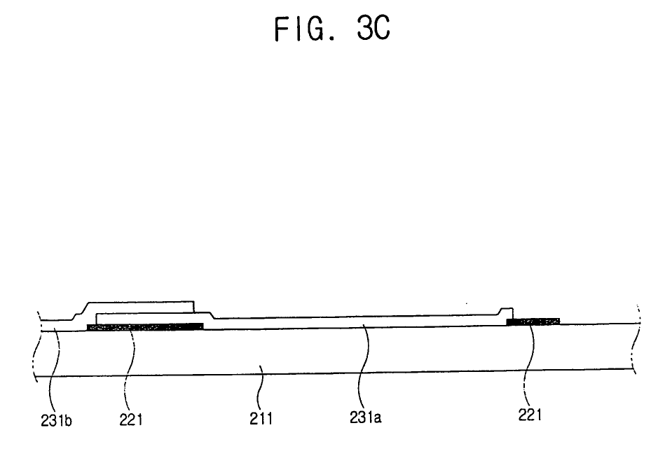

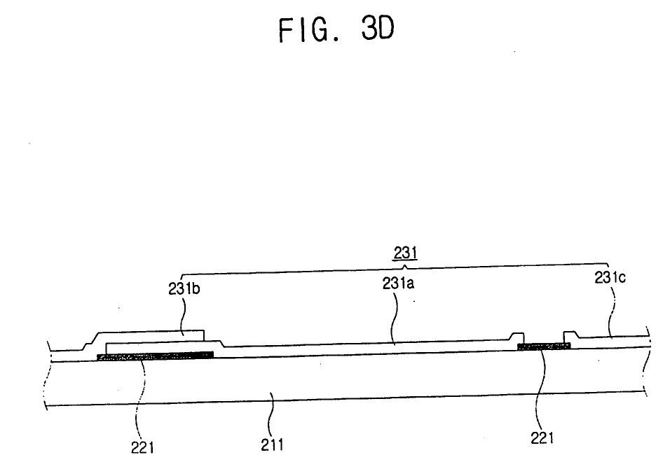

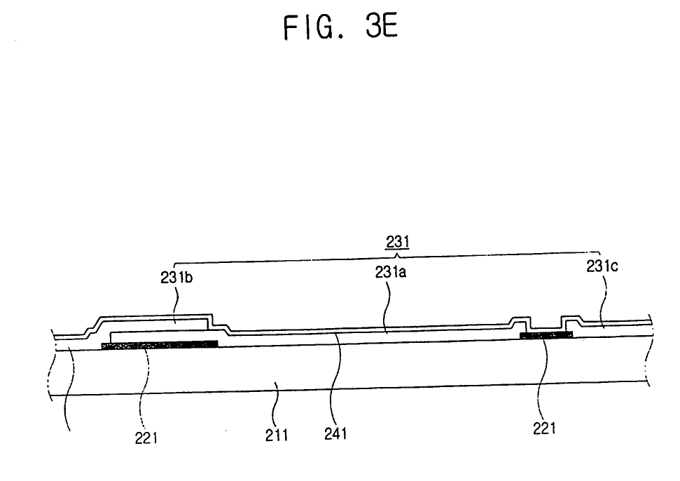

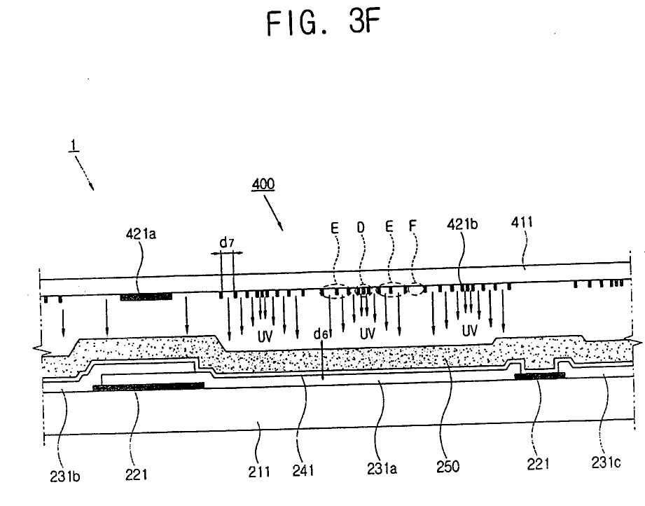

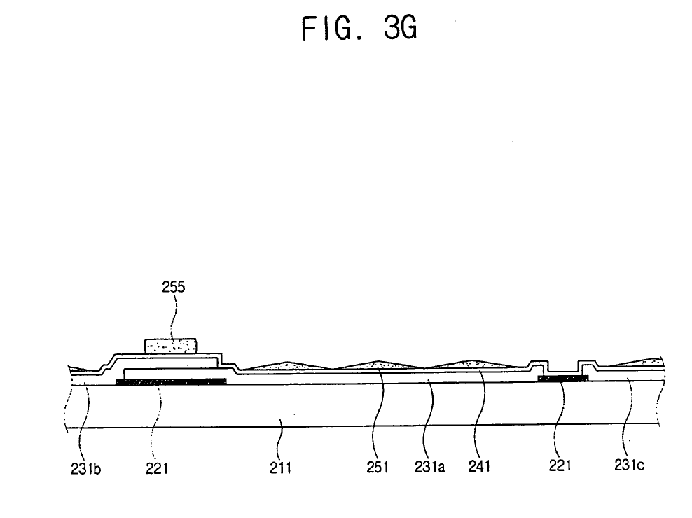

Hereinafter, a method of manufacturing the color filter substrate in accordance with an embodiment of the present invention will be described with reference to FIGS. 3A to 3G. The thin film transistor substrate 100 can be formed based on a conventional method, so the specific description therefor will be omitted for simplicity.

First, as shown in FIG. 3A, the black matrix 221 is formed on the second insulating substrate 211. The black matrix 221 is formed as following steps: First, black pigment is mixed with the photosensitive organic material to obtain a black matrix photosensitive liquid. As the black pigment, the carbon black or the titanium oxide can be used. Then, the black matrix photosensitive liquid is coated on the second insulating substrate 211, exposed, developed and baked to make the black matrix 221.

Next, as shown in FIG. 3b, the first sublayer 231a of red color is formed between the black matrixes 221. The formation of the sublayer 231a can be performed by coating, exposing, developing and baking a red color filter composition. At this time, a portion of the first sublayer 231a is located on the black matrix 221 for blocking the thin film transistor T to become the second region.

Next, as shown in FIG. 3C, the second sublayer 231b of green color is formed between the black matrixes 221. The second sublayer 231b does not overlap the first sublayer 231a in the first region, but overlaps the first sublayer 231a in the second region.

After that, as shown in FIG. 3D, the third sublayer 231c is formed between the black matrixes 221 to complete the color filter layer 231. In the completed color filter layer 231, any one of the three sublayers 231a, 231b, 231c is located in the first region, while any two of the three sublayers 231a, 231b, 231c overlap each other in the second region. Further, the black matrix 221 is also located at the second region.

Then, as shown in FIG. 3E, the common electrode 241 is formed on the color filter layer 231. The common electrode 241 can be formed by depositing the transparent conductive material such as indium tin oxide (ITO) or indium zinc oxide (IZO) using a sputtering method. The common electrode 241 is not subjected to a separate patterning process.

Next, as shown in FIG. 3F, the organic material layer 250 is formed on the color filter layer 231 and then exposed. The organic material layer 250 is photosensitive and formed, by spin coating or nozzle coating method such that, considering its thickness reduction during the development process, the thickness d6 of the organic material layer 250 is greater than the thickness d3 of the column spacer 255.

The mask 400 used in the exposing of the organic material layer 250 is provided with a mask substrate 411 and a light blocking pattern 421a, 421b. The mask substrate 411 is formed of quartz, and the light blocking patterns 421a, 421b are formed of chrome layers. The light blocking patterns 421a, 421b will be described below.

The light blocking pattern 421a corresponding to a position where the column spacer 255 is to be formed is formed so as to block light substantially 100%. The light blocking patterns 421b corresponding to a position where the organic layer mountain structure pattern 251 is to be formed is formed with slits. The light blocking patterns 421b are densely disposed at a portion D corresponding to the valley portion A of the organic layer mountain structure pattern 251, and are disposed at a portion E corresponding to the inclined portion B of the organic layer mountain structure pattern 251 such that the gaps therebetween becomes greater with the distance outward from the valley portion A. Further, the light blocking pattern 421b is not disposed at a portion F corresponding to the blank space portion C of the organic layer mountain structure pattern 251. By the aforementioned light blocking pattern 421b, intensity of the ultraviolet light used for the exposure of the organic material layer 250 becomes greater with the distance outward from the portion D as indicated by arrows.

If gaps d7 between the light blocking patterns 421b corresponding to the inclined portions B become greater, an uneven surface can be formed in the organic layer mountain structure pattern 251. However, in the embodiment of the present invention, since the column spacer 255 is formed within the second region with a greater height, the thickness d3 of the column spacer 255 is reduced, which leads to a reduction in the thickness d6 of the organic material layer 250. Therefore, the exposure dose for obtaining the organic layer mountain structure pattern 251 is also reduced, so that the gap d7 can be reduced.

FIG. 3G illustrates the organic layer mountain structure pattern 251 and the column spacer 255 completed through the exposure and development process of the organic material layer 250. Thus, the color filter substrate 200 is completed.

Manufacturing process of the liquid crystal display panel 1 will now be described as following.

After coating a sealant along a periphery of the completed color filter substrate 200, the liquid crystal layer 300 is formed by a dropping method. After that, the thin film transistor substrate 100 and the color filter substrate 200 are combined with each other and then the sealant is cured. At this time, the column spacer 255 of the color filter substrate 200 corresponds to the thin film transistor T of the thin film transistor substrate 100. The liquid crystal layer 300 can be formed by a filling method instead of the dropping method.

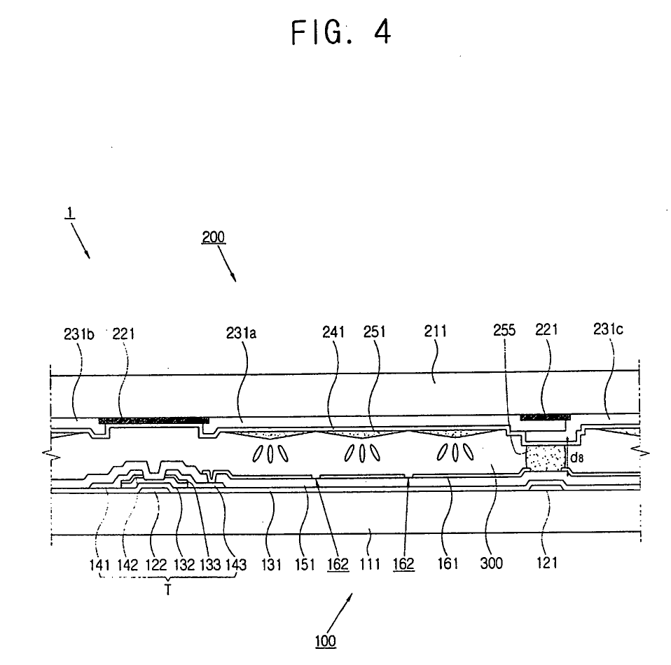

FIGS. 4 to 7 are cross-sectional views of a liquid crystal display panel in accordance with second to fifth embodiment of the present invention, respectively.

Referring to the embodiment shown in FIG. 4, the column spacer 255 is disposed above the upper surface of the gate line 121. Between the column spacer 255 and the second insulating substrate 211, the black matrix 221 and the two sublayers 231a, 231c overlapping each other are located. And between the column spacer 255 and the first insulating substrate 111, the gate line 121 is located. Therefore, it is possible to reduce a thickness d8 of the column spacer 255.

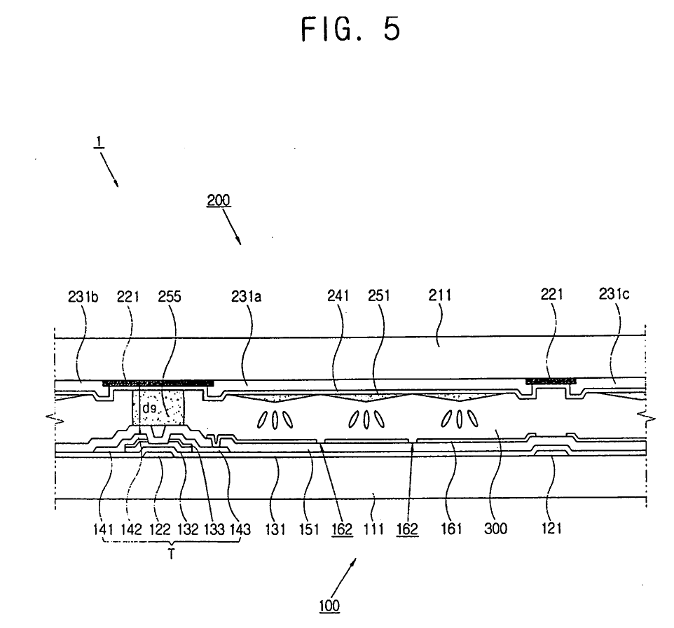

Referring to the embodiment shown in FIG. 5, the color filter layer 231 is not disposed between the column spacer 255 and the second insulating substrate 211. However, between the column spacer 255 and the second insulating substrate 211, the black matrix 221 is located. And between the column spacer 255 and the first insulating substrate 111, the thin film transistor T is located. Therefore, it is possible to reduce a thickness d9 of the column spacer 255.

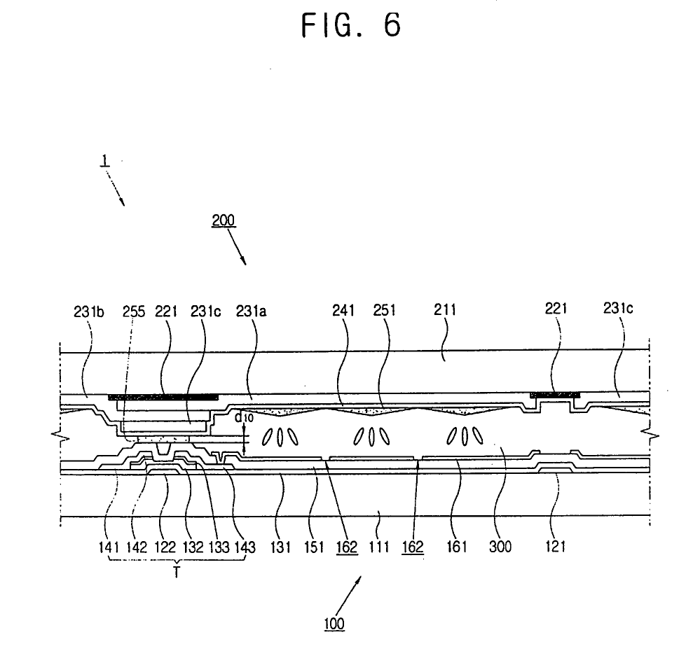

Referring to the embodiment shown in FIG. 6, the three sublayers 231a, 231b, 231c overlapping each other is located between the column spacer 255 and the second insulating substrate 211. Further, between the column spacer 255 and the first insulating substrate 111, the thin film transistor T is located. It is possible to further reduce a thickness d10 of the column spacer 255 by the three sublayers 231a, 231b, 231c overlapping each other, when compared to the above-described embodiment.

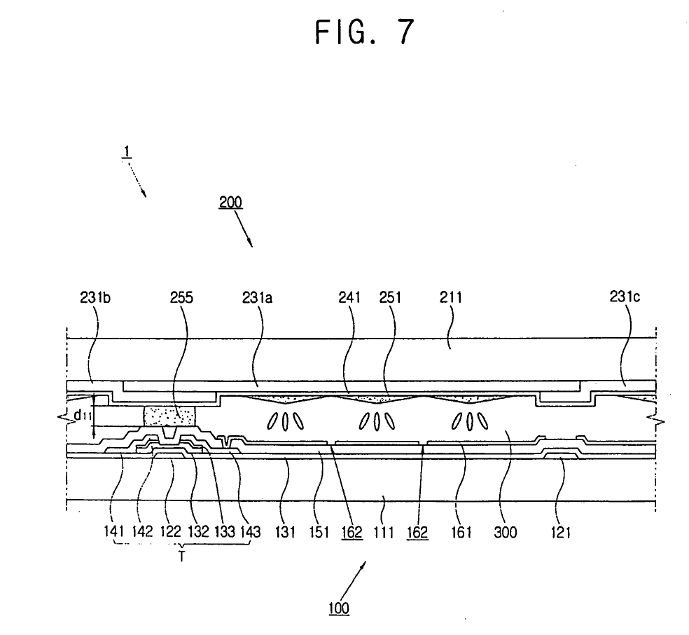

Referring to the embodiment shown in FIG. 7, no black matrix is formed. Instead of the black matrix, any two of the three sublayers 231a, 231b, 231c neighboring each other overlap each other to serve as the black matrix. Between the column spacer 255 and the second insulating substrate 211, any two of the three sublayers 231a, 231b, 231c are located. And between the column spacer 255 and the first insulating substrate 111, the thin film transistor T is located. Therefore, it is possible to reduce a thickness d11 of the column spacer 255.

As described above, in accordance with an embodiment of the present invention, there are provided a color filter substrate that is capable of improving the shape of an organic layer mountain structure pattern even when the organic layer mountain structure pattern and the column spacer are formed simultaneously, and a liquid crystal display panel including the same.

Further, in accordance with an embodiment of the present invention, there is provided a method of manufacturing a color filter substrate which is capable of improving the shape of an organic layer mountain structure pattern even when the organic layer mountain structure pattern and the column spacer are formed simultaneously, and a liquid crystal display panel.

Although exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A color filter substrate, comprising:
an insulating substrate;
a color filter layer disposed on the insulating substrate and provided with a first region and a second region higher than the first region;
an organic layer mountain structure pattern disposed in the first region and formed to protrude upward; and
a column spacer formed simultaneously with the organic layer mountain structure pattern and disposed in the second region.

2. The color filter substrate according to claim 1, wherein the color filter layer is provided with a plurality of sublayers of different respective colors, and at least two of the plurality of sublayers overlap each other in the second region.

3. The color filter substrate according to claim 2, further comprising a black matrix interposed between the insulating substrate and the color filter layer in the second region.

4. The color filter substrate according to claim 3, further comprising a common electrode disposed between the organic layer mountain structure pattern and the color filter layer, and disposed between the column spacer and the color filter layer.

5. A liquid crystal display panel, comprising:
a thin film transistor substrate on which a thin film transistor is formed;
a color filter substrate disposed opposite to the thin film transistor substrate, the color filter substrate including an insulating substrate; a color filter layer disposed on the insulating substrate and provided with a first region and a second region higher than the first region; an organic layer mountain structure pattern disposed in the first region and formed to protrude toward the thin film transistor substrate; and a column spacer disposed in the second region and formed from a layer used for forming the organic layer mountain structure pattern; and
a liquid crystal layer disposed between the thin film transistor substrate and the color filter substrate.

6. The panel according to claim 5, wherein the column spacer is disposed on the thin film transistor.

7. The panel according to claim 5, wherein the thin film transistor substrate is further provided with signal lines insulatedly intersecting each other, and the column spacer is disposed on the signal lines.

8. The panel according to claim 6, wherein the color filter layer is provided with a plurality of sublayers of different respective colors, and at least two of the plurality of sublayers overlap each other in the second region.

9. The panel according to claim 8, further comprising a black matrix interposed between the insulating substrate and the color filter layer in the second region.

10. The panel according to claim 8, wherein the color filter substrate further comprises a common electrode disposed between the organic layer mountain structure pattern and the color filter layer, and disposed between the column spacer and the color filter layer.

11. The panel according to claim 10, wherein the liquid crystal layer is formed of a vertical alignment mode liquid crystal.

12. The panel according to claim 11, wherein the thin film transistor substrate includes a pixel electrode with a pixel electrode incision pattern formed therein.

13. The panel according to claim 12, wherein a valley portion of the organic layer mountain structure pattern corresponds to the pixel electrode incision pattern.

14. A method for manufacturing a liquid crystal display panel, comprising:
forming a color filter layer with a first region and a second region higher than the first region on an insulating substrate;
forming a common electrode on the color filter layer;
forming an organic material layer on the common electrode layer;
patterning the organic material layer to form an organic layer mountain structure pattern protruding upward in the first region, and to form a column spacer in the second region, whereby a color filter substrate is prepared;
preparing a thin film transistor substrate having a thin film transistor; and
combining the color filter substrate and the thin film transistor substrate.

15. The method according to claim 14, wherein the color filter layer is provided with a plurality of sublayers of different respective colors, and at least two of the plurality of sublayers overlap each other in the second region.

16. The method according to claim 15, wherein the color filter substrate and the thin film transistor substrate are combined with each other so that the column spacer corresponds to the thin film transistor.

17. The method according to claim 14, wherein a thickness of the color filter layer of a first region in which the organic layer mountain structure pattern is disposed is less than a thickness of the color filter layer of the second region in which the column spacer is disposed.
